(19) United States
(12) Patent Application Publication
(10) Pub. No.: US 2007/0235125 A1
(43) Pub. Date: Oct. 11, 2007

(54) Article of apparel with graphic elements and method of manufacturing same

(76) Inventor: Dean R. Doeling, Hillsboro, OR (US)

Correspondence Address: BANNER & WITCOFF, LTD., 28 STATE STREET, 28th FLOOR, BOSTON, MA, 02109-9601, US

(21) Appl. No.: 11/393,001

(22) Filed: Mar. 29, 2006

(51) Int. Cl. B32B 37/00

(52) U.S. Cl. 156/256; 2/243.1

(57) ABSTRACT

A method of forming an article of apparel includes cutting an aperture in an article of a first material, cutting a sheet of a breathable material to form an insert and positioning the insert to substantially cover the aperture. A layer of adhesive material is secured to a second material to produce a laminated member, which is cut to form a bonding element substantially having the shape of the aperture, with an outer peripheral edge of the bonding element being slightly larger than the aperture and an inner peripheral edge of the bonding element being slightly smaller than the aperture. The bonding element is placed on the article of apparel such that a portion of the bonding element extends over a portion of the first material and a portion of the bonding element extends over a portion of the insert. The bonding element is secured to the insert and the first material.

### FIELD OF THE INVENTION

This invention relates generally to apparel, and, in particular, to a method of manufacturing apparel with lightweight and breathable graphics elements.

### BACKGROUND OF THE INVENTION

The use of graphics on apparel, and especially on athletic apparel, is well known. Such graphics often include letters and numbers to identify players on an athletic team, and may include logos or other graphic elements to identify the team. The graphic elements fastened to apparel are often formed of tackle twill and/or heat transfer materials, which can be heavy and non-breathable.

It would be desirable to provide a method of manufacturing apparel with graphics that reduces or overcomes some or all of the difficulties inherent in prior known devices. Particular objects and advantages will be apparent to those skilled in the art, that is, those who are knowledgeable or experienced in this field of technology, in view of the following disclosure of the invention and detailed description of certain embodiments.

### SUMMARY

The principles of the invention may be used to advantage to provide an article of apparel with graphic elements formed of breathable material and a method of manufacturing the same. In accordance with a first aspect, a method of forming an article of apparel includes cutting an aperture in an article of a first material, cutting a sheet of a breathable material to form an insert and positioning the insert to substantially cover the aperture. A layer of adhesive material is secured to a second material to produce a laminated member, which is cut to form a bonding element substantially having the shape of the aperture, with an outer peripheral edge of the bonding element being slightly larger than the aperture and an inner peripheral edge of the bonding element being slightly smaller than the aperture. The bonding element is placed on the article of apparel such that a portion of the bonding element extends over a portion of the first material and a portion of the bonding element extends over a portion of the insert. The bonding element is secured to the insert and the first material

In accordance with another aspect, a method of forming an article of apparel with a graphic element includes the steps of cutting at least one aperture in an article of apparel formed of a first material, cutting a sheet of a breathable material to form at least one insert and positioning each insert to cover at least a portion of at least one aperture. A layer of adhesive material is secured to a layer of a second material to produce at least one laminated member. The laminated member is cut to form at least one bonding element, with at least a portion of each bonding element configured to follow at least a portion of an outline of one of the apertures. Each bonding element is placed on the article of apparel such that the bonding element overlays a portion of the first material and a portion of the bonding element overlays a portion of at least one insert. Each laminated element to at least one insert and the first material.

In accordance with yet another aspect, an article of apparel with a graphic element includes a first material having an aperture formed therein. An insert formed of a breathable material is positioned to substantially cover the aperture. A bonding element is formed of an outer layer of a second material and an inner layer of adhesive material and has an outer peripheral edge that is slightly larger than the aperture and an inner peripheral edge that is slightly smaller than the aperture. The bonding element is secured to the article of apparel and the insert such that a portion of the bonding element extends over a portion of the first material and a portion of the bonding element extends over a portion of the insert.

In accordance with a further aspect, an article of apparel with a graphic element includes a first material having at least one aperture formed therein. At least one insert formed of a breathable material and positioned to cover at least one of the apertures. At least one bonding element is formed of an outer layer of a second material and an inner layer of adhesive material. Each bonding element is secured to the article of apparel and at least one of the inserts such that a portion of the bonding element extends over a portion of the first material and a portion of the bonding element extends over a portion of at least one of the inserts.

Substantial advantage is achieved by providing an article of apparel, and method of its manufacture, having graphic elements formed of a breathable material. In particular, certain embodiments of the article of apparel and its method of manufacture can provide an efficient and productive way to produce an article of apparel with improved breathability and light weight.

These and additional features and advantages disclosed here will be further understood from the following detailed disclosure of certain embodiments.

### BRIEF DESCRIPTION OF THE DRAWINGS

FIG. 1 is plan view of an article of apparel with graphic elements formed of a breathable material.

FIG. 2 is a plan view of the article of apparel of FIG. 1, shown during its manufacture with apertures cut therein.

FIG. 3 is a plan view of the article of apparel of FIG. 2, shown with inserts of breathable material positioned in the apertures.

FIG. 4 is a perspective view of a layer of material and a layer of adhesive used to form the bonding element of the article of apparel of FIG. 1.

FIG. 5 is an elevation view of a bonding apparatus used to adhere the layer of material and layer of adhesive of FIG. 4.

FIG. 6 is a plan view of the bonding element for the article of apparel of FIG. 1, shown being cut from the laminated member formed of the layer of material and layer of adhesive of FIG. 4.

FIG. 7 is a plan view, shown partially cut away, of another embodiment of an article of apparel with a graphic element of breathable material.

The figures referred to above are not drawn necessarily to scale and should be understood to provide a representation of the invention, illustrative of the principles involved. Some features of the method of manufacturing apparel depicted in the drawings have been enlarged or distorted relative to others to facilitate explanation and understanding. The same reference numbers are used in the drawings for similar or identical components and features shown in various alternative embodiments. Methods of manufacturing apparel as disclosed herein would have configurations and components determined, in part, by the intended application and environment in which they are used.

### DETAILED DESCRIPTION OF CERTAIN PREFERRED EMBODIMENTS

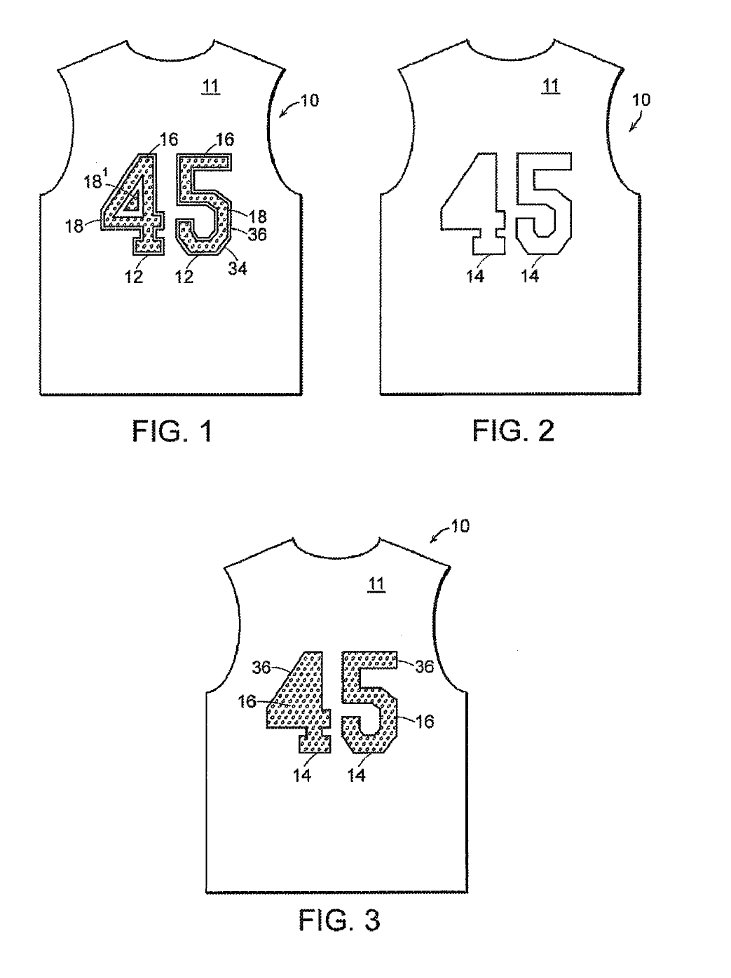

The present invention may be embodied in various forms. A preferred embodiment of an article of apparel 10 formed of a first textile material 11 and having one or more graphic elements 12 is shown in FIG. 1. In the illustrated embodiment, article of apparel 10 is an athletic jersey in the form of a tank top, with graphic elements 12 comprising numbers. Certain embodiments can be very useful for athletic apparel applications, since the graphic elements can provide identification of the individual wearing the jersey, and can improve breathability of the article of apparel and reduce its weight. First textile material 11 may be any manufacture of fibers, filaments or yarns, whether natural or synthetic. Exemplary materials for first textile material 11 include polyester, cotton, or blended fabrics. Other suitable materials for first textile material 11 will become readily apparent to those skilled in the art, given the benefit of this disclosure.

As illustrated here, graphic elements 12 are the numbers “4” and “5” which are combined to represent the number “45,” the jersey number for the individual wearing the article of apparel.

In certain embodiments, graphic elements 12 can be letters to be used to display the name of the wearer of the article of apparel, a team name, or any other desired indicator. In other embodiments, graphic element 12 could be a logo to represent the team for which an athlete wearing the article of apparel plays, a symbol, an alphanumeric character, or any other desired graphic element. Thus, it can be seen that graphic elements 12 can take any desired shape.

Further, any number of graphic elements 12 can be provided on article of apparel 10. Although two graphic elements 12 are shown in FIG. 1, it is to be appreciated that a single graphic element 12 could be provided on article of apparel 10. In other embodiments, more than two graphic elements 12 can be provided.

To manufacture article of apparel 10 with graphic elements 12, an aperture 14 is cut in article of apparel 10 having the shape of the outline of each desired graphic element 12, as seen in FIG. 2. An insert 16 having substantially the shape of aperture 14 is cut from a layer of material and positioned within each aperture 14. Insert 16 is configured to substantially cover aperture 14. In certain embodiments, insert 16 is cut so as to be slightly smaller than aperture 14 such that it fits within aperture 14. It is to be appreciated that in other embodiments insert 16 could be larger than aperture 14 and be positioned beneath or behind article of apparel 10, in which case insert 16 would entirely cover aperture 14 as seen from the front of article of apparel 10.

As seen here, two inserts 16, having the shapes of the numbers “4” and “5” are provided and positioned in the respective apertures 14. In the illustrated embodiment, the inserts 16 are slightly smaller than the corresponding apertures 14 and fit within apertures 14. The material used to form inserts 16 may be a lightweight breathable material, such as a mesh material formed of nylon, polyester, or other natural or synthetic blends.

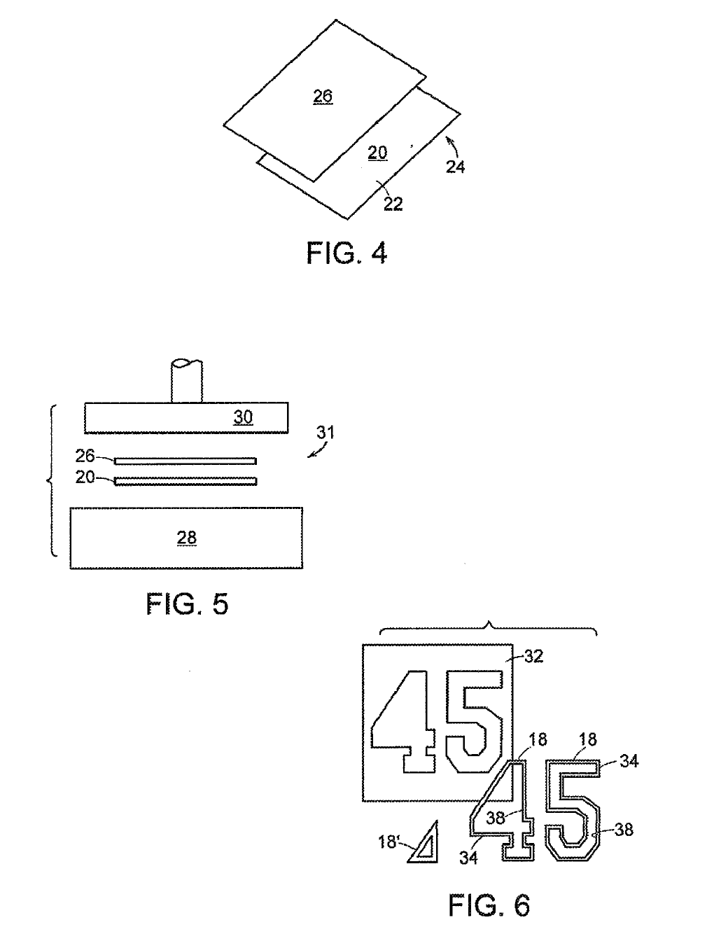

The creation of bonding elements 18 used to secure inserts 16 to article of apparel 10 is shown in FIGS. 4-6. A layer of adhesive material 20 having adhesive on its upper surface 22 and its lower surface 24 is secured to a layer of a second textile material 26, with adhesive material 26 forming an inner layer of bonding element 18 and second textile material 26 forming an outer layer of bonding element 18. Adhesive material 20 may be, for example, a polymer heat seal seam tape.

Adhesive material 20 and second textile material 26 may be secured to one another by the application of heat, for example, in embodiments where adhesive material 20 is a heat activated adhesive. Second textile material 26 may be any manufacture of fibers, filaments or yarns, whether natural or synthetic. Exemplary materials for second textile material 26 include tackle twill, polyester, cotton, or blended fabrics. Other suitable materials for second textile material 26 will become readily apparent to those skilled in the art, given the benefit of this disclosure.

With reference to FIG. 5, second textile material 26 and adhesive material 20 are depicted as being positioned adjacent to each other and between a surface 28 and a platen 30 of a bonding apparatus 31. Surface 28 may be a stationary component of the bonding apparatus upon which second textile material 26 and adhesive material 20 are placed. Platen 30, which is heated to an appropriate temperature, then translates toward surface 28 and compresses second textile material 26 and adhesive material 20 against surface 28. The combination of the heat and pressure supplied by platen 30 elevates the temperature of adhesive material 20 and ensures contact between second textile material 26 and adhesive material 20, thereby causing a portion of adhesive material 20 to infiltrate the structure of second textile material 26 to form a laminated member 32, seen in FIG. 6. Upon subsequent cooling, a portion of adhesive material 20 may solidify around the individual fibers or filaments in second textile material 26, thereby forming a bond.

The degree of heat utilized to melt adhesive material 20 is primarily dependent upon the materials forming second textile material 26 and adhesive material 20. As an initial consideration, the degree of heat should not melt or otherwise damage second textile material 26 prior to the melting of adhesive material 20, unless such melting of second textile material 26 is intended for forming the bond. This consideration aside, however, the degree of heat and pressure is generally related to the specific material forming adhesive material 20.

Adhesive material 20 may be formed of polyurethane, polyamide, polyester, polyolefin, or vinyl, for example. Suitable thermoplastic polymers formed from these materials may be supplied by Bemis Associates, Inc. of Shirley, Mass., United States.

Bonding apparatus 31 depicted in FIG. 5 is intended to provide one example of a structure suitable for forming the bond between second textile material 26 and adhesive material 20 to create laminated member 32. Alternately, surface 28 may be replaced by another heated platen, for example. Heat supplied through conduction is not the only method for forming this bond. Radio frequency and ultrasonic bonding may also be utilized to form this bond, which may require a substantially different type of bonding apparatus.

Once second textile material 26 and adhesive material 20 are bonded, individual bonding elements 18 are cut from laminated member 32 as seen in FIG. 6. Bonding elements 18 generally have the shape of the outline of an insert 16 and a corresponding aperture 14, with an outer peripheral edge 34 of each bonding element 18 being slightly larger than the outer peripheral edge 36 of the corresponding insert 16 and the inner peripheral edge 38 of bonding element 18 being slightly smaller than the outer peripheral edge 36 of the corresponding insert 16. Thus, when bonding element 18 is placed on article of apparel 10 with inserts 16 positioned within apertures 14, each bonding element 18 overlays a portion of insert 16 and the first textile material 11 of article of apparel 10 beyond aperture 14, thereby covering the gap between insert 16 and the periphery of aperture 14, or the line of overlap of insert 16 and aperture 14 in the event that insert 16 is larger than aperture 14 in any location.

With certain numbers, letters or other graphic elements, an additional bonding element 18′ may be cut from laminated member 32 to be positioned in a central area of insert 16. In the illustrated embodiment, bonding element 18′ serves to define the inner portion of the number “4.” It is to be appreciated that other numbers, e.g., the numbers “6” and “9” and letters, e.g., “P” and “0”, as well as other graphic elements may need such an inner bonding element. Such bonding elements 18 are simply placed at a desired location on insert 16.

It is to be appreciated that apertures 14 need not necessarily be cut in article of apparel 10 before bonding elements 18 are created, and that in certain embodiments bonding element 18 can be created before apertures 14 are cut in article of apparel 10.

Each bonding element 18 is then adhered to article of apparel 10 and its corresponding insert 16 using the apparatus seen in FIG. 5, or any other suitable bonding apparatus or bonding means, producing the article of apparel seen in FIG. 1.

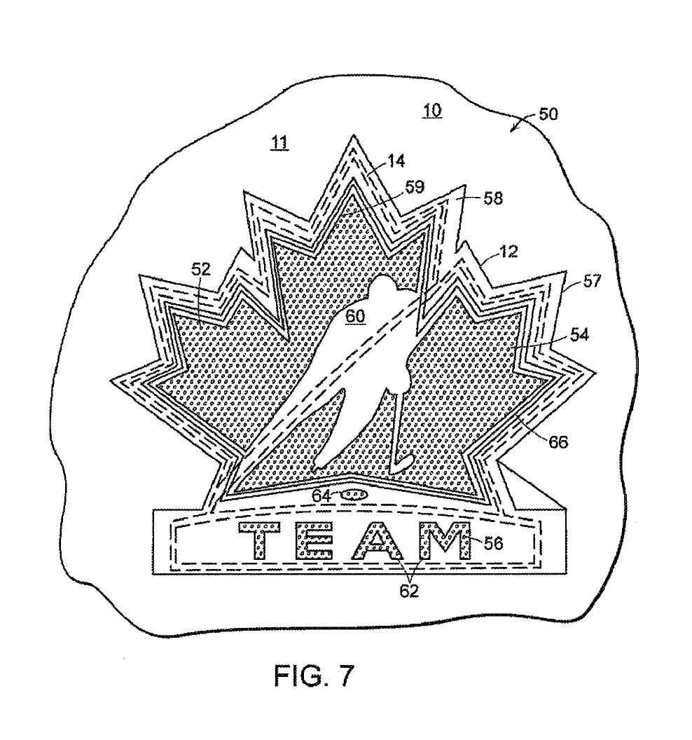

Another embodiment of an article of apparel 50 is seen in FIG. 7, shown partially cut away. The method of manufacture of article of apparel 50 is substantially the same as that described above with respect to the article of apparel 10. In this embodiment, article of apparel 50 has a single graphic element 12, which is more complex than the graphic element 12 seen above in FIG. 1.

Graphic element 12 has a plurality of inserts positioned within an aperture 14. In this embodiment, a first insert 52 is positioned in an upper portion of aperture 14, a second insert 54 is positioned in a central portion of aperture 14 and a third insert 56 is positioned in a lower portion of aperture 14. It is to be appreciated that each of the three inserts 52, 54, 56 may have a different color than that of the other two inserts, or that two of them may have one color while the other has a second color. It is to be appreciated that combination of colors for the inserts is considered to be within the scope of the present invention.

A bonding element 57 used to secure first insert 52, second insert 54 and third insert 56 to first material 11 of article of apparel 50 includes a peripheral portion 58 defining an aperture 59 and a bridge portion 60 spanning aperture 59. Peripheral portion 58 extends along aperture 14, and has a width sufficient to cover a portion of first material 11 and a portion of inserts 52, 54, and 56. Bridge portion 60 spans across aperture 14 and covers the gap between, or the area of overlap of, first insert 52 and second insert 54. In the illustrated embodiment, graphic element 12 is a team logo, shown here as the logo for a hockey team, and bridge portion 58 is in the form of a silhouette of a hockey player.

In this embodiment, bonding element 57 completely covers third insert 56 and the intersection of second insert 54 and third insert 56. It is to be appreciated that the intersection of second insert 54 and third insert 56 could be covered with an additional bridge portion of bonding element 57. Additionally, it should be noted that any number of inserts and bridge portions can be provided as part of graphic element 12.

A plurality of apertures 62 is formed in bonding element 57 over third insert 56, thus providing visibility of the breathable material of third insert 56 in the design formed by apertures 62. In the illustrated embodiment, apertures 62 are letters spelling out the name of the team, shown here as “TEAM,” worn by the user of article of apparel 50.

An oval shaped aperture 64 is formed in bonding element 57 proximate a lower edge of second insert 54 and beneath bridge portion 60, which depicts a hockey puck in this embodiment.

Thus, it can be seen that graphic element 12, can have a plurality of inserts in one or more apertures, and can have any desired shape, thereby providing a limitless number of possible configurations.

A trim member 66 is secured to the exterior surface of bonding element 57, providing a visual border about graphic element 12, enhancing its aesthetic appeal. Trim member 66 may be formed of a raised material, or a flat material, and is secured to bonding element 57 with adhesive or other suitable means.

In light of the foregoing disclosure of the invention and description of various embodiments, those skilled in this area of technology will readily understand that various modifications and adaptations can be made without departing from the scope and spirit of the invention. All such modifications and adaptations are intended to be covered by the following claims.

What is claimed is:

1. A method of forming an article of apparel with a graphic element comprising the following steps:
cutting an aperture in an article of apparel formed of a first material;
cutting a sheet of a breathable material to form an insert configured to substantially cover the aperture;
positioning the insert to substantially cover the aperture;
securing a layer of adhesive material to a layer of a second material to produce a laminated member;
cutting the laminated member to form a bonding element substantially having the shape of the aperture, an outer peripheral edge of the bonding element being slightly larger than the aperture and an inner peripheral edge of the bonding element being slightly smaller than the aperture;
placing the bonding element on the article of apparel such that a portion of the bonding element extends over a portion of the first material and a portion of the bonding element extends over a portion of the insert; and
securing the bonding element to the insert and the first material.

2. The method of claim 1, wherein the step of securing the layer of adhesive material to the layer of the second material to produce the laminated member includes the application of heat.

3. The method of claim 1, wherein the step of securing the layer of adhesive material to the layer of the second material to produce the laminated member includes the application of pressure.

4. The method of claim 1, wherein the step of securing the bonding element to the insert and the first material includes the application of heat.

5. The method of claim 1, wherein the step of securing the bonding element to the insert and the first material includes the application of pressure.

6. The method of claim 1, further comprising the steps of:
forming an additional aperture in the article of apparel having the shape of an additional graphic element;
forming an additional insert configured to substantially cover the additional aperture;
positioning the additional insert to substantially cover the additional aperture;
forming an additional bonding element substantially having the shape of the additional aperture, an outer peripheral edge of the additional bonding element being slightly larger than the additional aperture and an inner peripheral edge of the additional bonding element being slightly smaller than the additional aperture;
placing the additional bonding element on the article of apparel such that a portion of the additional bonding element extends over a portion of the first material and a portion of the additional bonding element extends over a portion of the additional insert; and
securing the additional bonding element to the additional insert and the first material.

7. The method of claim 1, wherein the second material is a tackle twill.

8. The method of claim 1, wherein the aperture has the shape of an alphanumeric character.

9. The method of claim 1, further comprising the step of securing a trim element to an exterior of the bonding element.

10. A method of forming an article of apparel with a graphic element comprising the following steps:
cutting at least one aperture in an article of apparel formed of a first material;
cutting a sheet of a breathable material to form at least one insert;
positioning each insert to cover at least a portion of at least one of the apertures;
securing a layer of adhesive material to a layer of a second material to produce at least one laminated member;
cutting the laminated member to form at least one bonding element, at least a portion of each bonding element configured to follow at least a portion of an outline of one of the apertures;
placing each bonding element on the article of apparel such that the bonding element overlays a portion of the first material and a portion of the bonding element overlays a portion of at least one insert; and
securing each laminated element to at least one insert and the first material.

11. The method of claim 10, wherein at least one bonding element comprises a peripheral portion defining a central aperture and a bridge portion extending across the central aperture.

12. The method of claim 11, wherein the bridge portion overlays a portion of a first insert and a portion of a second insert.

13. The method of claim 10, wherein the steps of securing the layer of adhesive material to the layer of the second material to produce the at least one laminated member includes the application of heat.

14. The method of claim 10, wherein the steps of securing the layer of adhesive material to the layer of the second material to produce the at least one laminated member includes the application of pressure.

15. The method of claim 10, wherein the step of securing each laminated element to at least one insert and the first material includes the application of heat.

16. The method of claim 10, wherein the step of securing each laminated element to at least one insert and the first material includes the application of pressure.

17. The method of claim 10, further comprising the step of securing a trim element to an exterior of the bonding element.

18. An article of apparel with a graphic element comprising, in combination:
a first material having an aperture formed therein;
an insert formed of a breathable material and positioned to substantially cover the aperture;
a bonding element formed of an outer layer of a second material and an inner layer of adhesive material and having an outer peripheral edge being slightly larger than the aperture and an inner peripheral edge being slightly smaller than the aperture, the bonding element being secured to the article of apparel and the insert such that a portion of the bonding element extends over a portion of the first material and a portion of the bonding element extends over a portion of the insert.

19. The article of apparel of claim 18, wherein the aperture has the shape of an alphanumeric character.

20. The article of apparel of claim 18, wherein the adhesive material is a heat-activated adhesive.

21. The article of apparel of claim 18, wherein the second material is a tackle twill.

22. The article of apparel of claim 18, further comprising a trim element secured to an exterior of the bonding element.

23. An article of apparel with a graphic element comprising, in combination:
a first material having at least one aperture formed therein;
at least one insert formed of a breathable material and positioned to cover at least a portion of at least one of the apertures; and
at least one bonding element formed of an outer layer of a second material and an inner layer of adhesive material, each bonding element being secured to the article of apparel and at least one of the inserts such that a portion of the bonding element extends over a portion of the first material and a portion of the bonding element extends over a portion of at least one of the inserts.

24. The article of apparel of claim 23, wherein at least one bonding element comprises a peripheral portion defining a central aperture and a bridge portion extending across the central aperture.

25. The article of apparel of claim 24, wherein the bridge portion overlays a portion of a first insert and a portion of a second insert.

26. The article of apparel of claim 23, wherein the outer layer and the inner layer of each bonding element are secured to one another with the application of heat.

27. The article of apparel of claim 23, wherein the outer layer and the inner layer of each bonding element are secured to one another with the application of pressure.

28. The article of apparel of claim 23, wherein each bonding element is secured to the article of apparel and at least one of the inserts with the application of heat.

29. The article of apparel of claim 23, wherein each bonding element is secured to the article of apparel and at least one of the inserts with the application of pressure.

30. The article of apparel of claim 23, further comprising a trim element secured to an exterior of at least one bonding element.
